(19) United States
(12) Patent Application Publication
(10) Pub. No.: US 2026/0281825 A1
(43) Pub. Date: Sep. 17, 2026

(54) POLICIES FOR ROAMING PREPARATION IN A SEAMLESS MOBILITY DOMAIN (SMD)

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/564,783

(22) Filed: Mar. 12, 2026

Related U.S. Application Data
(60) Provisional application No. 63/770,753, filed on Mar. 12, 2025.

(51) Int. Cl. H04W 36/00; H04W 36/18

(52) U.S. Cl. CPC H04W 36/0016; H04W 36/18

(57) ABSTRACT

Policies for roaming preparation in a Seamless Mobility Domain (SMD) may be provided. An Access Point (AP) Multi-Link Device (MLD) may receive a plurality of roaming preparation requests from a non-AP MLD to prepare a plurality of target AP MLDs for roaming by the non-AP MLD. Each of the first AP MLD and the plurality of target AP MLDs are members of a SMD, and the non-AP MLD is connected to the first AP MLD. The AP MLD may determine that a number of roaming preparation requests received from the non-AP MLD exceeds a maximum number of target AP MLDs allowed for roaming preparation, and reject one or more roaming preparation request of the plurality of roaming preparation requests exceeding the maximum number of target AP MLDs allowed for roaming preparation. The AP MLD may send a roaming preparation response for each rejected roaming preparation request.

### RELATED APPLICATION

Under provisions of 35 U.S.C. § 119(e), Applicant claims the benefit of U.S. Provisional Application No. 63/770,753, filed March 12, 2025, which is incorporated herein by reference.

### TECHNICAL FIELD

The present disclosure relates generally to policies for roaming preparation in a Seamless Mobility Domain (SMD).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for enabling policies for roaming preparation in a Seamless Mobility Domain (SMD);

FIG. 2 is a flow chart of a method for enabling policies for roaming preparation in a SMD; and

FIG. 3 is a block diagram of a computing device.

### DETAILED DESCRIPTION

### Overview

Policies for roaming preparation in a Seamless Mobility Domain (SMD) may be provided. A first Access Point (AP) Multi-Link Device (MLD) may receive a plurality of roaming preparation requests from a non-AP MLD to prepare a plurality of target AP MLDs for roaming by the non-AP MLD. Each of the first AP MLD and the plurality of target AP MLDs may be members of a SMD. The non-AP MLD may be connected to the first AP MLD. The first AP MLD may determine that a number of roaming preparation requests received from the non-AP MLD exceeds a maximum number of target AP MLDs allowed for roaming preparation in the SMD. The first AP MLD may reject, in response to determining that the number of roaming preparation requests received from the non-AP MLD exceeds the maximum number of target AP MLDs allowed for roaming preparation in SMD, one or more roaming preparation request of the plurality of roaming preparation requests exceeding the maximum number of target AP MLDs allowed. The first AP MLD may send a roaming preparation response for each of the one or more rejected roaming preparation requests. The roaming preparation response may indicate the rejection of an associated roaming preparation request.

Both the foregoing overview and the following example implementations are examples and explanatory only and should not be considered to restrict the disclosure’s scope, as described and claimed. Furthermore, features and/or variations may be provided in addition to those described. For example, implementations of the disclosure may be directed to various feature combinations and sub-combinations described in the example implementations.

### EXAMPLE IMPLEMENTATIONS

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Seamless roaming capability has been an area of interest for improving roaming quality within wireless networks. For instance, the next generation of the Institute of Electrical and Electronics Engineers (IEEE) 802.11 (that is, Wi-Fi 8) may seek roaming enhancements to support more reliable and seamless roaming. To achieve seamless roaming, a roaming transition time and delays added due to roaming related operations may need to be reduced. In one example, to support seamless roaming, a Station (STA) may create an association with a Seamless Mobility Domain (SMD) instead of with an individual Access Point (AP) Multi-Link Devices (MLDs). Associating with a SMD may enable the STA to roam seamlessly between member AP MLDs of the SMD without requiring reassociation and reestablishment of contexts with each new AP MLD. That is, associating with a SMD may ensure that when the STA moves from the current AP MLD to a target AP MLD, the STA may not need to perform reassociation and rekeying, and the STA context may be transferred from the current AP MLD to the target AP MLD to achieve seamless roaming. Thus, by enabling the STA to associate with a SMD that includes multiple member AP MLDs may significantly reduce roaming time to realize seamless roaming (e.g., smooth and continuous roaming with no apparent interruption in data communication) and significantly improve a STA’s wireless performance in terms of increased throughput, reduced latency, and higher range, as illustrative, non-limiting examples.

Seamless roaming may have two phases: a roaming preparation phase and a roaming execution phase. In the roaming preparation phase, the STA prepares a target AP MLD in advance for roaming transition in near future. The roaming preparation phase may involve link setup, context transfer, and Quality-of-Service (QoS) related resource reservation on the target AP MLD. Once a non-AP MLD (that is, the STA) has performed the roaming preparation with a target AP MLD, it then may perform the roaming execution to that target AP MLD to roam to that target AP MLD. The roaming execution phase may involve dynamic context transfer and changing a Distribution System (DS) mapping for the non-AP MLD from the current AP MLD to the target AP MLD.

In some deployments, such as, Industrial Internet of Things (IIoT), Automated Guided Vehicles (AGVs), Autonomous Mobile Robots (AMRs), etc., a STA may benefit from preparing more than one target AP MLD (for example, two or three target AP MLDs) and then roam to one of those target AP MLDs based on client’s actual mobility. Support for roaming preparation of multiple target AP MLDs may already be supported by the IEEE 802.11. Also, for keeping protocol simplicity, the IEEE 802.11 may agree to support preparing each target AP MLD using a separate roaming request/response exchange. To avoid misuse of this feature, the disclosure provides the AP MLD to have some policy in terms of what may be allowed for roaming preparation, such that STAs may not request to prepare a large number of potential target AP MLDs, resulting in waste of network resources. Embodiments of the disclosure, for example, may define roaming preparation policy and advertising the roaming preparation policy in a SMD.

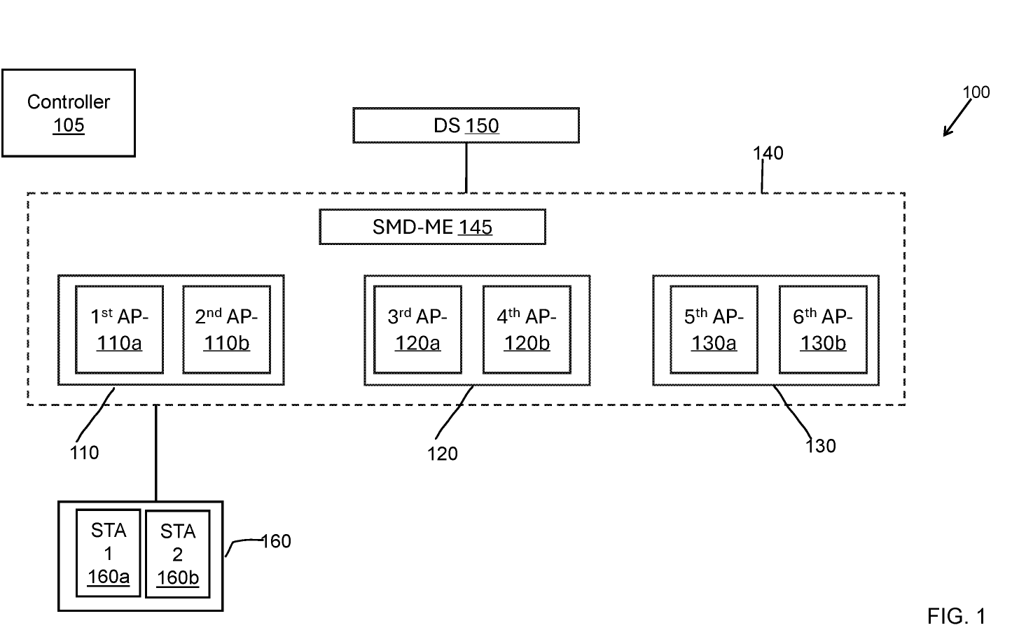

FIG. 1 is a block diagram of an operating environment 100 for enabling policies for roaming preparation in a SMD. As shown in FIG. 1, operating environment 100 may comprise a controller 105, a plurality of AP MLDs, for example, a first AP MLD 110, a second AP MLD 120, and a third AP MLD 130. Each of the plurality of AP MLDs may include one or more APs. For example, first AP MLD 110 may include a first AP 110a and a second AP 110b, second AP MLD 120 may include a third AP 120a and a fourth AP 120b, and third AP MLD 130 may include a fifth AP 130a and a sixth AP 130b.

Operating environment 100 may further include a SMD 140, an SMD Management Entity (SMD ME) 145, a DS 150, and a non-AP MLD 160. Non-AP MLD 160 may include a first STA 160a and a second STA 160b. SMD 140 includes a plurality of AP MLDs (that is, first AP MLD 110, second AP MLD 120, and third AP MLD 130) each with a Media Access Control (MAC)-Service Access Point (SAP) to DS 150.

SMD ME 145 may enable converged architecture for the plurality of AP MLDs of SMD 140. SMD ME 145 may enable a SMD mode for the plruality of AP MLDs. The SMD mode may enable non-AP MLD 160 to roam seamlessly between member AP MLDs without requiring reassociation and reestablishment of contexts with each new AP MLD. SMD ME 145 may be a logical entity and may be hosted on controller 105 or distributed on one or more of first AP MLD 110, second AP MLD 120, and third AP MLD 130. DS 150 may include wired ethernet or a mesh network used to connect multiple AP MLDs of SMD 140.

SMD 140 may provide a coverage environment, for example, but is not limited to, a Wireless LAN (WLAN) that may provide wireless network access (e.g., access to the WLAN for non-AP MLD 160 as it moves within the coverage environment). First STA 160a and second STA 160b each may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device.

Each of the plurality of APs may be compatible with specification standards such as, but not limited to, the IEEE 802.11 specification standard for example. The plurality of APs and STAs of operating environment 100 may use Multi-Link Operation (MLO) where they simultaneously transmit and receive across different bands and channels by establishing two or more links to two or more AP radios. These bands may comprise, but are not limited to the 2 GHz band, the 5 GHz band, the 6 GHz band, and the 60 GHz band.

Controller 105 may comprise a WLC and may provision and control the coverage environment (for example, a WLAN). In some implementations of the disclosure, controller 105 may be implemented by a Digital Network Architecture Center (DNAC) controller (i.e., a Software-Defined Network (SDN) controller.

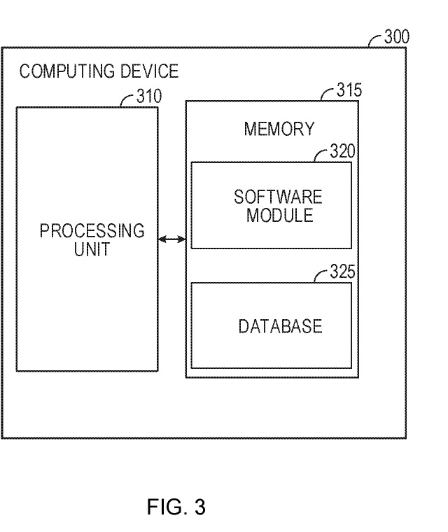

The elements described above of operating environment 100 (e.g., controller 105, first AP MLD 110, second AP MLD 120, third AP MLD 130, SMD 140, SMD ME 145, DS 150, and non-AP MLD 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

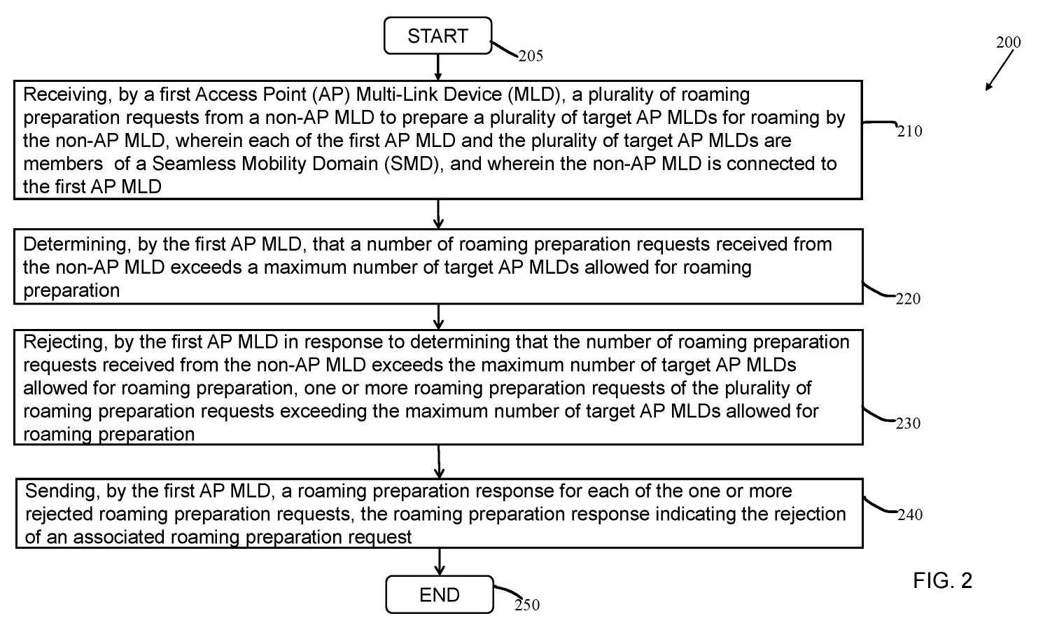

FIG. 2 is a flow chart setting forth the general stages involved in a first method 200 consistent with implementations of the disclosure for enabling policies for roaming preparation in SMD 140. First method 200 may be implemented using first AP MLD 120 or SMD 140 as described in more detail above with respect to FIG. 1. In some examples, first method 200 may be implemented using any of the plurality of AP MLDs as described in more detail above with respect to FIG. 1. Ways to implement the stages of method 200 will be described in greater detail below.

Method 200 may begin at starting block 205 and proceed to stage 210 where first AP MLD 110 may receive a plurality of roaming preparation requests from non-AP MLD 160 to prepare a plurality of target AP MLDs for roaming by non-AP MLD 160. Each of first AP MLD 110 and the plurality of target AP MLDs may be members of SMD 140. Non-AP MLD 160 may be connected to first AP MLD 110 or connected to SMD 140 through first AP MLD 110. In examples, the roaming preparation requests may be received in response to non-AP MLD 160 intending to or anticipating to move from it’s current with first AP MLD 110 to another AP MLD (for example, second AP MLD 120, third AP MLD 130, etc.) of SMD 140.

In one example, non-AP MLD 160 may send the plurality of roaming preparation request for preparing more than one target AP MLDs in SMD 140. For example, non-AP MLD 160 may prepare multiple target AP MLDs in SMD 140 in anticipation of an upcoming roaming event. In anticipation of the roaming, non-AP MLD 160 may prepare multiple potential target AP MLDs so that the roaming is seamless. These roaming preparation requests may be sent for each target AP MLD and may be sent one at a time or together.

After receiving the plurality of roaming preparation requests from non-AP MLD 160 at stage 210, method 200 may proceed to stage 220 where first AP MLD 110 may determine whether a number of roaming preparation requests received from non-AP MLD 160 exceeds a maximum number of target AP MLDs allowed for roaming preparation. For example, and as discussed above, non-AP MLD 160 may send the plurality of roaming preparation requests for preparing more than one target AP MLDs for an upcoming roaming event. First AP MLD 110 may update a total number of the roaming preparation requests received from non-AP MLD 160 when it receives a roaming preparation request from non-AP MLD 160. First AP MLD 110 then may compare the total number of roaming preparation requests received from non-AP MLD 160 with the maximum number of target AP MLDs allowed for roaming preparation. The maximum number of target AP MLDs allowed for roaming preparation for a given seamless roaming procedure may be predefined for SMD 140 or for each member AP MLD (for example, first AP MLD 110) of SMD 140.

Once having determined that the number of roaming preparation requests received from non-AP MLD 160 exceeds the maximum number of target AP MLDs allowed for roaming preparation at stage 220, method 200 may proceed to stage 230 where first AP MLD 110 may reject one or more roaming preparation requests of the plurality of roaming preparation requests exceeding the maximum number of target AP MLDs allowed for roaming preparation.

After rejecting the one or more roaming preparation requests at stage 230, method 200 may proceed to stage 240 where first AP MLD 110 may send a roaming preparation response for each of the one or more rejected roaming preparation requests. Each roaming preparation response may indicate rejection of an associated roaming preparation request. This may ensure that when performing seamless roaming, non-AP MLD 160 may not request to prepare more the predetermined number of target AP MLDs before it performs the roaming transition to one of those target AP MLDs. If non-AP MLD 160 exceeds the maximum allowed number of target AP MLDs for the roaming preparation, first AP MLD 110 may reject one or more roaming preparation requests exceeding the maximum number of target AP MLDs allowed for roaming preparation and send a reject response for rejected roaming preparation request. The roaming preparation response may include a status code indicating a reason for rejection. An example status code may include Rejected_Max_Target_AP_MLD_Limit_Exceeded_for_Roaming_Prep.

In some implementations, first AP MLD 110 may process each roaming preparation request received from non-AP MLD 160. After preparing the target AP MLDs from the roaming preparation requests, first AP MLD 110 may determine whether the total number of prepared target AP MLDs is more than the maximum number of target AP MLDs allowed for roaming preparation. In response to determining that the total number of prepared target AP MLDs is more than the maximum number of target AP MLDs allowed for roaming preparation, first AP MLD 110 may select and retain the maximum number of target AP MLDs allowed for roaming preparation. First AP MLD 110 may then message non-retained target AP MLDs to un-prepare itself. In addition, first AP MLD 110 may reject one or more roaming preparation requests corresponding to non-retained target AP MLDs. Once having sent the roaming preparation response for each of the one or more rejected roaming preparation requests at stage 230, method 200 may terminate at end block 240.

When non-AP MLD 160 completes the roaming to one of the prepared target AP MLDs, the total number of the roaming preparation requests for non-AP MLD 160 may be reset. In some other implementations, the total number of the roaming preparation requests for non-AP MLD 160 may be reset after a pre-determined time if non-AP MLD 160 did not roam to one of the prepared target AP MLDs in the pre-determined time.

In example implementations, a maximum roaming preparation rate allowed for SMD 140 may also be defined. The maximum roaming preparation rate may define a maximum number of successful roaming preparation requests for one or more target AP MLDs that are allowed by member AP MLDs and/or SMD 140 over a defined period of time (for example, a roaming preparation rate interval). The maximum roaming preparation rate may be meant to define a rate limit for the successful roaming preparation requests that may be accepted by member AP MLDs or SMD 140. In one example, the maximum roaming preparation rate this can indicate that a member AP MLD may accept a maximum of X (for example, 5) successful roaming preparation requests over a time period P (for example, 2 sec). The time period may be defined as a multiple of Beacon Intervals (BIs) (for example, 20 BIs ( approximately equal to 2 sec) for the roaming preparation rate interval). The maximum roaming preparation rate limit may apply independent of whether the roaming preparation requests are for the same target AP MLD or different target AP MLDs. Hence, the maximum roaming preparation rate limit may apply even when non-AP MLD 160 may be sending roaming preparation requests to only one target AP MLD. For example, non-AP MLD 160 may be allowed only 5 successful roaming preparation requests/response exchange within 2 sec interval (that is, 20 BIs). In addition, the maximum roaming preparation rate limit may apply for the roaming preparation requests until a successful roaming transition is performed. If non-AP MLD 160 exceeds the maximum roaming preparation rate limit, first AP MLD 110 may send a reject response for the roaming prepare request with a status code indicating a reason for rejection. An example status code may include Rejected_Roaming_Prep_Rate_Limit_Exceeded.

In example implementations, the roaming preparation on a target AP MLD (for example, second AP MLD 120) may expire after a predetermined time period if the roaming transition was not executed within that time period. In some examples, non-AP MLD 160 may prepare a target AP MLD through back to back roaming preparation request to ensure that links are always prepared for non-AP MLD 160 on that target AP MLD when non-AP MLD 160 needs to roam. This may lead to waste of resources. Hence, member AP MLDs or SMD 140 may define a policy not allowing non-AP MLD 160 to keep preparing the same AP MLD (for example, second AP MLD 120) through back to back roaming preparation requests. The current AP MLD (that is, first AP MLD 110) may reject a subsequent roaming preparation request for a target AP MLD if the subsequent roaming preparation request is for an already prepared target AP MLD and if the set of requested links are the same in both previous and subsequent roaming preparation requests. The roaming preparation response for the subsequent roaming preparation request may include a status code to indicate this policy. And example status code to indicate this policy may include Rejected_Target_AP_MLD_Already_Prepared). If non-AP MLD 160 requests to change a set of links for an already prepared target AP MLD, then non-AP MLD 160 may send another roaming preparation request with the revised set of links. In this scenario, the current AP MLD (that is, first AP MLD 110) may accept the revised roaming preparation request from the non-AP MLD 160.

In example implementations, AP MLD side policy for roaming preparation may be defined at SMD level or at member AP MLD level. It may be more beneficial to define these roaming preparation policies at SMD level, so non-AP MLD 160 may see a consistent policy within entire SMD 140.

In example implementations, a SMD level policy for roaming preparation may be advertised in a SMD element. For example, the SMD element may include one or more of the following fields: a maximum target AP MLDs allowed for roaming preparation field; a maximum roaming preparation rate allowed field; and a roaming preparation rate interval field. These roaming preparation parameters may be provided by member AP MLDs in a beacon, a probe response, an association response, a reassociation response, an Operating Mode Notification (OMN) management frame, a roaming response frame (if parameters have changed), or any other management frame. Different AP MLDs in SMD 140 may have different capabilities in terms of preparing neighbor AP MLDs. If a network has different policy for roaming preparation per AP MLD or per a group of neighboring AP MLDs, then different policy may be advertised by different AP MLDs in SMD 140. This may be a seamless roaming related element that may provide AP MLD specific policy, provided in a beacon, a probe response, a (re)association response, an OMN management frame, a roaming response frame, etc. When discovering neighbor AP MLDs, then this roaming preparation policy may also be advertised in a Neighbor Report (NR) element for the neighboring APs.

Non-AP MLD 160 may also receive AP MLD's policy related to roaming preparation and in general other roaming related policy (for example, a data forwarding policy, a resource reservation policy, a pre-roaming preparation related policy, etc.) in a beacon, a probe response, a (re)association response, an OMN management frame, a roaming response frame, etc.

In example implementations, if first AP MLD 110 determines that non-AP MLD 160 is not following the roaming preparation policy more than a predetermined number of times, then first AP MLD 110 may reject the roaming preparation request from non-AP MLD 160 even before the policy limit. For example, if non-AP MLD 160 is not following the roaming preparation policy over and over again and keeps sending a large number of roaming preparation requests (that is, more than the maximum allowed limit), then first AP MLD 110 may reject subsequent roaming preparation request from non-AP MLD 160 even before it violates any policy limit. In this implementation, a status code may be sent in the roaming preparation response to signal the repeat policy violation. An example status code for the repeat policy violation may include Rejected_Roaming_Prep_Policy_Violated.

In some other implementations, first AP MLD 110 may reject some roaming preparation requests from non-AP MLD 160 due to other reasons (for example, a temporary network resource constraint). In such implementations, first AP MLD 110 may send a status code in the roaming preparation response to signal rejection due to resource unavailability. An example status code to signal rejection due to resource unavailability may include Rejected_Roaming_Prep_Reosurce_Unavailable.

Thus, embodiments of the disclosure may define AP MLD side policies for roaming preparation phase of the seamless roaming. These policies may be used when SMD 140 or member AP MLDs allow roaming preparation for multiple target AP MLDs. These policies may also be used when the roaming preparation may be allowed for a single target AP MLD.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for enabling policies for roaming preparation in SMD 140 as described above with respect to FIG. 2. Computing device 300, for example, may provide an operating environment for controller 105, first AP MLD 110, second AP MLD 120, third AP MLD 130, SMD 140, SMD-ME 145, DS 150, and non-AP MLD 160. Controller 105, first AP MLD 110, second AP MLD 120, third AP MLD 130, SMD 140, SMD-ME 145, DS 150, and non-AP MLD 160 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 600 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 600 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving, by a first Access Point (AP) Multi-Link Device (MLD), a plurality of roaming preparation requests from a non-AP MLD to prepare a plurality of target AP MLDs for roaming by the non-AP MLD, wherein each of the first AP MLD and the plurality of target AP MLDs are members of a Seamless Mobility Domain (SMD), and wherein the non-AP MLD is connected to the first AP MLD;
determining, by the first AP MLD, that a number of roaming preparation requests received from the non-AP MLD exceeds a maximum number of target AP MLDs allowed for roaming preparation;
rejecting, by the first AP MLD in response to determining that the number of roaming preparation requests received from the non-AP MLD exceeds the maximum number of target AP MLDs allowed for roaming preparation, one or more roaming preparation request of the plurality of roaming preparation requests exceeding the maximum number of target AP MLDs allowed; and
sending, by the first AP MLD, a roaming preparation response for each of the one or more rejected roaming preparation request, the roaming preparation response indicating the rejection of an associated roaming preparation request.

2. The method of claim 1, further comprising:
determining whether a number of successful roaming preparation requests received from the non-AP MLD exceeds a maximum number of successful roaming preparation requests allowed by the first AP MLD or the SMD over a defined period of time.

3. The method of claim 2, further comprising:
rejecting at least one successful roaming preparation request of a plurality of successful roaming preparation requests exceeding the maximum number of successful roaming preparation requests allowed by the first AP MLD or the SMD over the defined period of time.

4. The method of claim 1, wherein roaming preparation on a target AP MLD expires after a period of time in response to roaming transition not being executed to the target AP MLD within a time period.

5. The method of claim 1, further comprising:
rejecting a subsequent roaming preparation request in response to determining that the subsequent roaming preparation request is for an already prepared target AP MLD if a set of requested links in the subsequent roaming preparation request are same as the already prepared target AP MLD.

6. The method of claim 1, wherein the roaming preparation response comprises a status code indicating a reason for rejection.

7. The method of claim 1, further comprising:
providing the maximum number of target AP MLDs allowed for roaming preparation in a SMD element, wherein the SMD element comprises a maximum target AP MLDs allowed for roaming preparation field.

8. A system comprising:
a memory storage; and
a processing unit coupled to the memory storage, wherein the processing unit is operative to:
receiving, by a first Access Point (AP) Multi-Link Device (MLD), a plurality of roaming preparation requests from a non-AP MLD to prepare a plurality of target AP MLDs for roaming by the non-AP MLD, wherein each of the first AP MLD and the plurality of target AP MLDs are members of a Seamless Mobility Domain (SMD), and wherein the non-AP MLD is connected to the first AP MLD;
determining, by the first AP MLD, that a number of roaming preparation requests received from the non-AP MLD exceeds a maximum number of target AP MLDs allowed for roaming preparation;
rejecting, by the first AP MLD in response to determining that the number of roaming preparation requests received from the non-AP MLD exceeds the maximum number of target AP MLDs allowed for roaming preparation, one or more roaming preparation request of the plurality of roaming preparation requests exceeding the maximum number of target AP MLDs allowed; and
sending, by the first AP MLD, a roaming preparation response for each of the one or more rejected roaming preparation request, the roaming preparation response indicating the rejection of an associated roaming preparation request.

9. The system of claim 8, wherein the processing unit is further operative to:
determine whether a number of successful roaming preparation requests received from the non-AP MLD exceeds a maximum number of successful roaming preparation requests allowed by the first AP MLD or the SMD over a defined period of time.

10. The system of claim 9, wherein the processing unit is further operative to:
reject at least one successful roaming preparation request of a plurality of successful roaming preparation requests exceeding the maximum number of successful roaming preparation requests allowed by the first AP MLD or the SMD over the defined period of time.

11. The system of claim 8, wherein roaming preparation on a target AP MLD expires after a period of time in response to roaming transition not being executed to the target AP MLD within a time period.

12. The system of claim 8, wherein the processing unit is further operative to:
reject a subsequent roaming preparation request in response to determining that the subsequent roaming preparation request is for an already prepared target AP MLD if a set of requested links in the subsequent roaming preparation request are same as the already prepared target AP MLD.

13. The system of claim 8, wherein the roaming preparation response comprises a status code indicating a reason for rejection.

14. The system of claim 8, wherein the processing unit is further operative to:
provide the maximum number of target AP MLDs allowed for roaming preparation in a SMD element, wherein the SMD element comprises a maximum target AP MLDs allowed for roaming preparation field.

15. A non-transitory computer-readable medium that stores a set of instructions which when executed perform a method executed by the set of instructions comprising:
receiving, by a first Access Point (AP) Multi-Link Device (MLD), a plurality of roaming preparation requests from a non-AP MLD to prepare a plurality of target AP MLDs for roaming by the non-AP MLD, wherein each of the first AP MLD and the plurality of target AP MLDs are members of a Seamless Mobility Domain (SMD), and wherein the non-AP MLD is connected to the first AP MLD;
determining, by the first AP MLD, that a number of roaming preparation requests received from the non-AP MLD exceeds a maximum number of target AP MLDs allowed for roaming preparation;
rejecting, by the first AP MLD in response to determining that the number of roaming preparation requests received from the non-AP MLD exceeds the maximum number of target AP MLDs allowed for roaming preparation, one or more roaming preparation request of the plurality of roaming preparation requests exceeding the maximum number of target AP MLDs allowed; and
sending, by the first AP MLD, a roaming preparation response for each of the one or more rejected roaming preparation request, the roaming preparation response indicating the rejection of an associated roaming preparation request.

16. The non-transitory computer readable medium of claim 15, further comprising:
determining whether a number of successful roaming preparation requests received from the non-AP MLD exceeds a maximum number of successful roaming preparation requests allowed by the first AP MLD or the SMD over a defined period of time.

17. The non-transitory computer-readable medium of claim 16, further comprising:
rejecting at least one successful roaming preparation request of a plurality of successful roaming preparation requests exceeding the maximum number of successful roaming preparation requests allowed by the first AP MLD or the SMD over the defined period of time.

18. The non-transitory computer-readable medium of claim 15, wherein roaming preparation on a target AP MLD expires after a period of time in response to roaming transition not being executed to the target AP MLD within a time period.

19. The non-transitory computer-readable medium of claim 15, further comprising:
rejecting a subsequent roaming preparation request in response to determining that the subsequent roaming preparation request is for an already prepared target AP MLD if a set of requested links in the subsequent roaming preparation request are same as the already prepared target AP MLD.

20. The non-transitory computer-readable medium of claim 15, wherein the roaming preparation response comprises a status code indicating a reason for rejection.
